(19) United States
(12) Patent Application Publication
(10) Pub. No.: US 2024/0241856 A1
(43) Pub. Date: Jul. 18, 2024

(54) METHOD AND APPARATUS FOR COMPATIBILITY OF FILE AGGREGATION, COMPUTER DEVICE AND STORAGE MEDIUM

(71) Applicant: SUZHOU METABRAIN INTELLIGENT TECHNOLOGY CO., LTD., Suzhou, Jiangsu (CN)

(72) Inventors: Zhiyang XIE, Suzhou, Jiangsu (CN); Guodong XIAO, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/574,636

(22) PCT Filed: Mar. 29, 2022
(86) PCT No.: PCT/CN2022/083738

§ 371 Date: Dec. 27, 2023

(30) Foreign Application Priority Data
Oct. 29, 2021 (CN) 202111268961.7

(51) Int. Cl. G06F 16/11; G06F 16/16; G06F 16/182

(52) U.S. Cl. CPC G06F 16/128; G06F 16/164; G06F 16/182

(57) ABSTRACT

A method and apparatus for compatibility between a snapshot and small file aggregation under a distributed file storage system, and a computer device and a storage medium are provided. The method includes: receiving, by a Metadata Server (MDS), an operation request sent by a client, and when the operation request is an opening request, determining whether there is an O_TRUNC identifier in a file; when there is the O_TRUNC identifier in the file, continuing to determine whether the file is an aggregated small file and has a snapshot; when the file is the aggregated small file and has the snapshot, returning an error indicator to the client; and converting, by the client, the aggregated small file into a normal small file after receiving the error indicator; and triggering a Copy-On-Write (COW) or deletion operation of an object of the small file, so as to ensure that snapshot data is correct.

### CROSS-REFERENCE TO RELATED APPLICATION

The present application is a National Stage Application of PCT International Application No.: PCT/CN2022/083738 filed on Mar. 29, 2022, which claims priority to Chinese Patent Application 202111268961.7, filed in the China National Intellectual Property Administration on Oct. 29, 2021, the disclosure of which is incorporated herein by reference in its entirety.

### TECHNICAL FIELD

The present disclosure relates to the field of distributed file storage systems, and particularly to a method and apparatus for compatibility between a snapshot and small file aggregation under a distributed file storage system, a computer device and a storage medium.

### BACKGROUND

A snapshot, also known as instant copy, is a mirror image of a dataset at a particular moment, and is a complete usable copy of the dataset. The previous state of the data set may be checked or restored according to the snapshot. If a write operation to an original storage system occurs during the process of using the snapshot, original data of a corresponding data unit is stored into the snapshot. The data unit is divided into current data, and data at a certain time point in the snapshot, and other data that is not updated is shared in the snapshot and the original storage system. The flexibility and the efficient use of a storage space that can be achieved by a virtual view make the virtual view a dominant snapshot technology.

The snapshot in a file system is implemented based on a Copy-On-Write (COW) mechanism. When a file is changed, COW is triggered to generate a snapshot version and a head version.

CephFS is a file storage solution provided by Ceph, and is a storage type of that file system that supports a POSIX interface. In the CephFS, file data is stored in the form of an object which occupies 4 MB by default. When a small file, e.g., a file of 1 KB, is stored, the data still needs to occupy one object, which occupies 4 MB. When a large amount of small files needs to be stored, a lot of resources will be wasted. Large files are aggregated, and small files (which are less than or equal to, e.g., 512 KB) are written to a special type of file (aggregated file) in a close arrangement manner (e.g., aligned per 4 KB). When it is needed to read a file, an object of a source file is no longer read, instead, source file data is read from the object of the aggregated file. In this way, the resource utilization rate may be greatly improved for a small file scenario (as shown in FIG. 1).

However, after the small files are aggregated, operations such as reading, writing, and deleting the small files are actually performed on the corresponding large file. If there is a snapshot for the small file, when write and deletion operations are performed, what an Operating System Deployment (osd) receives is a snapshot domain (null) of the large file, such that COW cannot be normally triggered, and therefore the snapshot of the small file cannot work properly. As shown in FIG. 2, when a small file ino1 is modified, since COW cannot be triggered, the snapshot and head version still point to data in the aggregated large file, as a result, the data of such snapshot is always consistent with the head version, which makes it impossible for the snapshot to achieve its intended functions.

### SUMMARY

Based on this, a method and apparatus for compatibility between a snapshot and small file aggregation under a distributed file storage system, a computer device and a storage medium are provided for addressing the above technical problems.

In an aspect, the embodiments of the present disclosure provide a method for compatibility between a snapshot and small file aggregation under a distributed file storage system. The method includes the following operations S201 to S206.

At S201, a Metadata Server (MDS) receives an operation request sent by a client, when the operation request is an opening request, determines whether there is an O_TRUNC identifier in a file, and when there is the O_TRUNC identifier in the file, executes S202.

At S202, the MDS determines whether the file is an aggregated small file and has a snapshot, and when the file is the aggregated small file and has the snapshot, executes S203.

At S203, the MDS returns an error indicator to the client.

At S204, the client converts the aggregated small file into a normal small file after receiving the error indicator.

At S205, after completing the conversion, the client sends the opening request to the MDS again.

At S206, after receiving the opening request again, the MDS performs a truncate operation, and triggers a COW operation of an object of the small file, so as to ensure that snapshot data is correct.

In an embodiment, the operation of determining whether the file is the aggregated small file in S202 includes determining whether a size of an original file is less than a first threshold.

In an embodiment, the operation of converting, by the client, the aggregated small file into the normal small file in S204 includes the following operations.
a) An aggregation attribute of the aggregated small file is acquired, an aggregated large file is found and opened according to the aggregation attribute, and data of the small file is read from the aggregated large file, where the aggregation attribute includes an inode of the small file and an offset of the small file.
b) The data of the small file is written to a new object.
c) A setxattr request is sent to update metadata of the small file in the MDS.
d) The inode of the small file in an object header in the aggregated large file is emptied.

In an embodiment, in S201, when a file is opened in an O_TRUNC manner, after receiving a request, the MDS executes the truncate operation on the file to empty data of the file.

In an embodiment, the operation request further includes a deletion operation.

In an embodiment, the method may further include the following operation.

After receiving the deletion request sent by the client, the MDS determines whether there is an O_TRUNC identifier in the file, when there is the O_TRUNC identifier in the file, continues to determine whether the file is the aggregated small file and has the snapshot, and when the file is the aggregated small file and has the snapshot, returns the error indicator to the client; after receiving the error indicator, the client converts the aggregated small file into the normal small file, and sends the deletion operation to the MDS again; and after receiving the deletion request again, the MDS performs the truncate operation, and triggers the deletion operation of the object of the small file, so as to ensure that the snapshot data is correct.

In an embodiment, the operation request may further include a read operation.
a) When an object to be read is a snapshot, and the snapshot has an aggregation attribute.
b) Metadata of a latest version of the snapshot is acquired, and an aggregation attribute of the metadata is acquired; and when an aggregation attribute of the latest version of the snapshot is not consistent with the aggregation attribute of the metadata, the aggregation attribute of the metadata is modified to the aggregation attribute of the latest version of the snapshot.
c) The subsequent read operation is continued.

In an embodiment, when it is determined in S201 that there is no O_TRUNC identifier in the file, or it is determined in S202 that the file is not the aggregated small file or has no snapshot, the method ends.

In an embodiment, when the MDS determines that there is no O_TRUNC identifier in the file, or determines that the file is not the aggregated small file and has the snapshot, the method ends.

In another aspect, the embodiments of the present disclosure provide an apparatus for compatibility between a snapshot and small file aggregation under a distributed file storage system. The apparatus includes an MDS and a client. The apparatus may further include a determination module, an execution module, and an operation module.

After the MDS receives a read or deletion request sent by the client, the determination module determines whether there is an O_TRUNC identifier in a file, and when there is the O_TRUNC identifier in the file, continues to determine whether the file is an aggregated small file and has a snapshot; and when the file is the aggregated small file and has the snapshot, the MDS returns an error indicator to the client.

The client converts the aggregated small file into a normal small file after receiving the error indicator; and after completing the conversion, the client sends an opening or deletion request to the MDS again.

After receiving the opening or deletion request again, the MDS performs a truncate operation, and triggers a COW or deletion operation of an object of the small file, so as to ensure that snapshot data is correct.

In a still another aspect, the embodiments of the present disclosure provide a computer device, which includes a memory, one or more processors, and a computer-readable instruction that is stored in the memory and executable on the one or more processors. The one or more processors, when executing the computer-readable instruction, implement operations of the method for compatibility between the snapshot and the small file aggregation under the distributed file storage system provided in any one of the above embodiments.

In a still another aspect, the embodiments of the present disclosure provide one or more non-volatile computer-readable storage media, storing a computer-readable instruction. The computer-readable instruction, when being executed by one or more processors, enables the one or more processors to execute operations of the method for compatibility between the snapshot and the small file aggregation under the distributed file storage system provided in any one of the above embodiments.

The details of one or more embodiments of the present disclosure are set forth in the drawings and the description below. Other features and advantages of the present disclosure will be apparent from the drawings and the claims from the specification.

### BRIEF DESCRIPTION OF THE DRAWINGS

FIG. 1 is a schematic diagram of aggregation of small files.

FIG. 2 is a schematic diagram of performing write and deletion operations on aggregated small files in the related art.

FIG. 3 is an application environment diagram of a method for compatibility between a snapshot and small file aggregation under a distributed file storage system.

FIG. 4 is a schematic flowchart of a method for compatibility between a snapshot and small file aggregation under a distributed file storage system according to one or more embodiments.

FIG. 5 is a structural block diagram of an apparatus for compatibility between a snapshot and small file aggregation under a distributed file storage system according to one or more embodiments.

FIG. 6 is an internal structure diagram of a computer device according to one or more embodiments.

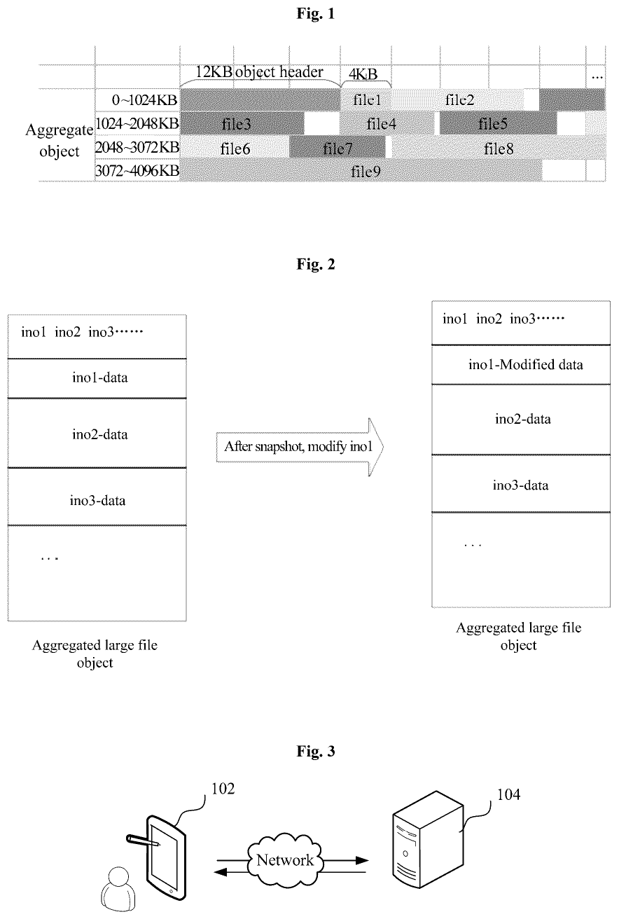

### DETAILED DESCRIPTION OF THE EMBODIMENTS

To make the objectives, technical solutions, and advantages of the present disclosure clearer, the present disclosure is further described in detail below with reference to the drawings and embodiments. It should be understood that the exemplary embodiments described here are merely used to explain the present disclosure, and are not used to limit the present disclosure.

The method for compatibility between the snapshot and the small file aggregation under the distributed file storage system provided in the embodiments of the present disclosure may be applied to an application environment shown in FIG. 3. A client 102 communicates with a Metadata Server (MDS) 104 via a network. After receiving a request sent by the client 102, the MDS 104 determines whether there is an O_TRUNC identifier in a file, when there is the O_TRUNC identifier in the file, continues to determine whether the file is an aggregated small file and has a snapshot, and when the file is the aggregated small file and has the snapshot, returns an error indicator to the client 102; and after receiving the error indicator, the client converts the aggregated small file into a normal small file, and normally triggers an operation on an object of the small file, so as to ensure that snapshot data is correct. The client 102 may be, but not limited to, a variety of personal computers, notebook computers, smartphones, tablet computers, and portable wearable devices; and the MDS 104 may be implemented by using an independent server or a server cluster consisting of a plurality of servers.

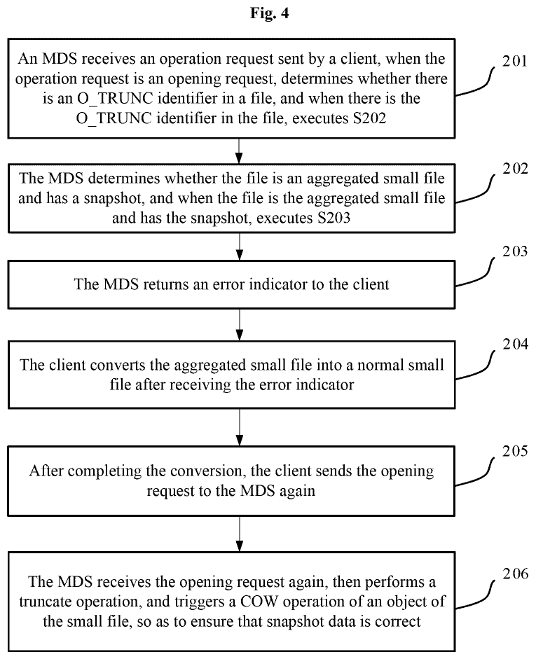

In an embodiment, as shown in FIG. 4, provided is a method for compatibility between a snapshot and small file aggregation under a distributed file storage system. The method includes the following operations.

When the client opens a file in an O_TRUNC manner, after receiving a request, the MDS first executes a truncate operation on the file to empty data of the file. When the client calls an open interface, the file is not opened yet, and the data in the cache of the client cannot be guaranteed to be the latest data, therefore, whether the file is the aggregated small file needs to be determined in the MDS.

At S201, an MDS receives an operation request sent by a client, when the operation request is an opening request, determines whether there is an O_TRUNC identifier in a file, and when there is the O_TRUNC identifier in the file, executes S202. In the present embodiment, the MDS executes the determination operation in response to the operation request being the opening request.

At S202, the MDS determines whether the file is an aggregated small file and has a snapshot, and when the file is the aggregated small file and has the snapshot, executes S203.

At S203, the MDS returns an error indicator to the client.

At S204, the client converts the aggregated small file into a normal small file after receiving the error indicator.

At S205, after completing the conversion, the client sends the opening request to the MDS again.

At S206, after receiving the opening request again, the MDS performs a truncate operation, and triggers a COW operation of an object of the small file, so as to ensure that snapshot data is correct. The error indicator may be a specific error code.

Based on the above, when there is no O_TRUNC identifier in the file, or when the file is not the aggregated small file and has the snapshot, the method ends, and the subsequent operations are not executed.

In the method for compatibility between the snapshot and the small file aggregation under the distributed file storage system, after receiving the operation request sent by the client, the MDS determines whether there is an O_TRUNC identifier in the file, when there is the O_TRUNC identifier in the file, continues to determine whether the file is the aggregated small file and has the snapshot, and when the file is the aggregated small file and has the snapshot, returns the error indicator to the client; and after receiving the error indicator, the client converts the aggregated small file into the normal small file, and triggers the COW or deletion operation of the object of the small file, that is, when data of the aggregated small file is changed, the small file is first converted into the normal small file, and then the data of the small file is operated, such that the COW of the small file may be triggered, so as to ensure that the snapshot data is correct.

The operation of determining whether the file is the aggregated small file in S202 includes: determining whether a size of an original file is less than a first threshold. In CephFS, file data is stored in the form of an object, and the object is 4 MB by default. The first threshold may be preset.

During a write operation, since the file has been opened, it may be ensured that data in the cache of the client is correct, such that modification may be performed directly in a write process of the client; and when the file is the aggregated small file and has the snapshot, the aggregated small file is first converted into the normal small file. The exemplary conversion method includes the following operations.
a) An aggregation attribute of the aggregated small file is acquired, an aggregated large file is found and opened, and data of the small file is read from the aggregated large file; wherein the aggregation attribute includes an inode of the small file and an offset of the small file.
b) The data of the small file is written to a new object.
c) A setxattr request is sent to update metadata of the small file in the MDS.
d) The inode of the small file in an object header in the aggregated large file is emptied.

The operation request may further include a deletion operation. The deletion operation is the same as the read operation. After receiving the deletion request sent by the client, the MDS determines whether there is an O_TRUNC identifier in the file, when there is the O_TRUNC identifier in the file, continues to determine whether the file is the aggregated small file and has the snapshot, and when the file is the aggregated small file and has the snapshot, returns the error indicator to the client; after receiving the error indicator, the client converts the aggregated small file into the normal small file, and sends the deletion operation to the MDS again; and after receiving the deletion request again, the MDS triggers the deletion operation of the object of the small file when performing the truncate operation, so as to ensure that the snapshot data is correct.

Likewise, similar as the above, when there is no O_TRUNC identifier in the file, or when the file is not the aggregated small file and has the snapshot, the method ends, and the subsequent operations are not executed. In an aggregated file, a plurality of source files share one object, therefore, the space occupied cannot be actually released by deleting the source files, resulting in waste of storage space; and moreover, due to reduction of the number of the source files, a cache hit rate is reduced when the file is read, affecting read performance.

A task for defragmentation is to calculate the percentage of valid data in the aggregated file out of the total size of the aggregated file, and clear the aggregated file when the percentage is less than a set threshold, so as to improve the utilization rate of the storage space and improve the read performance of the small file.

Defragmentation is to re-integrate valid small files into a new aggregated large file, such that invalid spaces may be released, and the aggregation attribute in the metadata of the small file needs to be modified. If there is the cache of the snapshot in the client, and defragmentation occurs simultaneously, since the snapshot in a system is read-only, snapshot metadata is not synchronized in the client, such that the metadata of the snapshot in the client still points to an old aggregated large file. If the data of the snapshot is acquired at the moment, the acquisition fails because the old aggregated large file has been deleted. Therefore, a read process of the snapshot needs to be amended as follows.
a) When an object to be read is a snapshot, and the snapshot has an aggregation attribute.
b) Metadata of a latest version of the snapshot is acquired, and an aggregation attribute of the metadata is acquired; and when an aggregation attribute of the latest version of the snapshot is not consistent with the aggregation attribute of the metadata, the aggregation attribute of the metadata is modified to the aggregation attribute of the latest version of the snapshot.

Specifically, metadata of a head version is acquired; when the head version has no aggregation attribute, it indicates that the data of the small file has changed, such that the aggregation attribute of the snapshot is clear; and when the aggregation attribute of the head version is inconsistent with the aggregation attribute of the metadata, it indicates that defragmentation occurs, and the aggregation attribute of the metadata is modified to the aggregation attribute of the head version.
c) The subsequent read operation is continued.

It is to be understood that, although the various operations in the flowcharts of FIG. 4 are displayed in sequence as indicated by the arrows, these operations are not necessarily executed in sequence in the order indicated by the arrows. Unless otherwise specified herein, there is no strict order for the execution of these operations, and these operations can be executed in other orders. Moreover, at least part of the operations in FIG. 4 may include a plurality of sub-operations or a plurality of stages. These sub-operations or stages are not necessarily executed at a same time, but can be executed at different times. These operations or stages are not necessarily executed in sequence, but may be executed in turns or alternately with other operations or at least a part of the sub-operations or stages in other operations.

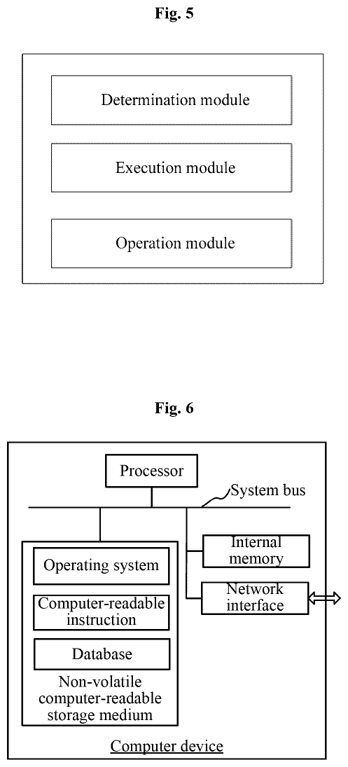

In another aspect, as shown in FIG. 5, provided is an apparatus for compatibility between a snapshot and small file aggregation under a distributed file storage system. The apparatus includes an MDS and a client. The apparatus may further include a determination module, an execution module, and an operation module.

After the MDS receives a read or deletion request sent by the client, the determination module determines whether there is an O_TRUNC identifier in a file, and when there is the O_TRUNC identifier in the file, continues to determine whether the file is an aggregated small file and has a snapshot; and when the file is the aggregated small file and has the snapshot, the MDS returns an error indicator to the client.

The client converts the aggregated small file into a normal small file after receiving the error indicator; and after completing the conversion, the client sends an opening or deletion request to the MDS again.

After receiving the deletion request again, the MDS performs a truncate operation, and triggers a COW or deletion operation of an object of the small file, so as to ensure that snapshot data is correct.

The determination module is configured to determine whether the file is the aggregated small file in a following manner: determining whether a size of an original file is less than a first threshold. In CephFS, file data is stored in the form of an object, and the object is 4 MB by default. The first threshold may be preset.

During a write operation, since the file has been opened, it may be ensured that data in the cache of the client is correct, such that modification may be performed directly in a write process of the client; and when the file is the aggregated small file and has the snapshot, the aggregated small file is first converted into the normal small file. The exemplary conversion method includes the following operations.
a) An aggregation attribute of the aggregated small file is acquired, an aggregated large file is found and opened according to the aggregation attribute, and data of the small file is read from the aggregated large file, where the aggregation attribute includes an inode of the small file and an offset of the small file.
b) The data of the small file is written to a new object.
c) A setxattr request is sent to update metadata of the small file in the MDS.
d) The inode of the small file in an object header in the aggregated large file is emptied.

The operation request may further include a deletion operation. The deletion operation is the same as the read operation. After receiving the deletion request sent by the client, the MDS determines whether there is an O_TRUNC identifier in the file, when there is the O_TRUNC identifier in the file, continues to determine whether the file is the aggregated small file and has the snapshot, and when the file is the aggregated small file and has the snapshot, returns the error indicator to the client; after receiving the error indicator, the client converts the aggregated small file into the normal small file, and sends the deletion operation to the MDS again; and after receiving the deletion request again, the MDS triggers the deletion operation of the object of the small file when performing the truncate operation, so as to ensure that the snapshot data is correct.

In an aggregated file, a plurality of source files share one object, such that the space occupied cannot be actually released by deleting the source files, resulting in waste of storage space; and moreover, due to reduction of the number of the source files, a cache hit rate is reduced when the file is read, affecting read performance.

A task for defragmentation is to calculate the percentage of valid data in the aggregated file out of the total size of the aggregated file, and clear the aggregated file when the percentage is less than a set threshold, so as to improve the utilization rate of the storage space and improve the read performance of the small file.

Defragmentation is to re-integrate valid small files into a new aggregated large file, such that invalid spaces may be released, and the aggregation attribute in the metadata of the small file needs to be modified. If there is the cache of the snapshot in the client, and defragmentation occurs simultaneously, since the snapshot in a system is read-only, snapshot metadata is not synchronized in the client, such that the metadata of the snapshot in the client still points to an old aggregated large file. If the data of the snapshot is acquired at the moment, the acquisition fails because the old aggregated large file has been deleted. Therefore, a read process of the snapshot needs to be amended as follows.
a) When an object to be read is a snapshot, and the snapshot has an aggregation attribute.
b) Metadata of a latest version of the snapshot is acquired, and an aggregation attribute of the metadata is acquired; and when an aggregation attribute of the latest version of the snapshot is not consistent with the aggregation attribute of the metadata, the aggregation attribute of the metadata is modified to the aggregation attribute of the latest version of the snapshot.
c) The subsequent read operation is continued.

A specific limitation for the apparatus for compatibility between the snapshot and the small file aggregation under a distributed file storage system may refer to the limitation for the method for compatibility between the snapshot and the small file aggregation under the distributed file storage system, and thus not described herein again. Each module in the apparatus for compatibility between the snapshot and the small file aggregation under the distributed file storage system may be implemented entirely or partly by software, hardware, or a combination thereof. The foregoing modules may be embedded in or independent of a processor in a computer device in the form of hardware, or may be stored in a memory in the computer device in the form of software, such that the processor calls the foregoing modules and executes the operations corresponding to the foregoing modules.

An embodiment provides a computer device. The computer device may be a server. An internal structure diagram of the server may be shown in FIG. 6. The computer device includes one or more processors, a memory, a network interface, and a database, which are connected via a system bus. The processor of the computer device is configured to provide calculation and control capabilities. The memory of the computer device includes a non-volatile storage medium or an internal memory. The non-volatile storage medium stores an operating system, a computer-readable instruction, and a database. The internal memory provides an environment for the running of the operating system and the computer-readable instruction in the non-volatile storage medium. The database of the computer device is configured to store aggregated data. The network interface of the computer device is configured to be communicatively connected to an external terminal via a network. the method for compatibility between the snapshot and the small file aggregation under the distributed file storage system is implemented the computer-readable instruction, when being executed by a processor.

It may be understood by those having ordinary skill in the art that the structure shown in FIGS. 5 to 6, which is only a block diagram of a portion of the structure associated with the solutions of the embodiments of the present disclosure, does not constitute a limitation of the computer device to which the solutions of the embodiments of the present disclosure are applied. In some exemplary implementations, the computer device may include more or fewer components than shown in the figures, or be combined with certain components, or have a different arrangement of components.

An embodiment provides a computer device, which includes a memory, one or more processors, and a computer-readable instruction that is stored in the memory and executable on the one or more processors. The one or more processors, when executing the computer-readable instruction, implement operations of the method for compatibility between the snapshot and the small file aggregation under the distributed file storage system provided in any one of the above embodiments.

In an embodiment, this embodiment of the present disclosure further provides one or more non-volatile computer-readable storage media, storing a computer-readable instruction. The computer-readable instruction, when being executed by one or more processors, enables the one or more processors to execute operations of the method for compatibility between the snapshot and the small file aggregation under the distributed file storage system provided in any one of the above embodiments.

Those having ordinary skill in the art will appreciate that implementing all or part of the processes in the methods described above may be accomplished by instructing associated hardware by a computer-readable instruction, which may be stored in a non-volatile computer-readable storage medium, which, when executed, may include processes as embodiments of the methods described above. Any reference to a memory, storage, a database, or other media used in the embodiments provided in the present disclosure may include nonvolatile and/or volatile memories. The non-volatile memories may include a Read-Only Memory (ROM), a Programmable ROM (PROM), an Electrically Programmable ROM (EPROM), an Electrically Erasable And Programmable ROM (EEPROM), or a flash memory. The volatile memories may include a Random Access Memory (RAM), or an external cache memory. As not a limitation but an illustration, the RAM is available in many forms, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchronous Chain Channel (Synchlink) DRAM (SLDRAM), a Direct Memory Bus Dynamic RAM (DRDRAM), and a Memory Bus Dynamic RAM (RDRAM), among others.

Various technical features of the above embodiments may be combined arbitrarily. For brevity of description, description is not made to all possible combinations of the various technical features of the above embodiments. However, all the combinations of these technical features should be considered to fall within the scope of disclosure contained in the specification as long as there is no contradiction between the combinations of those technical features.

The above embodiments merely illustrate several implementations of the present disclosure, which are specifically described in detail, but are not to be construed as limiting the scope of the present disclosure. It should be pointed out that those having ordinary skill in the art can also make some modifications and improvements without departing from the concept of the present disclosure, and these modifications and improvements all fall within the scope of protection of the present disclosure. Accordingly, the scope of the present disclosure should be subject to the appended claims.

1. A method for compatibility between a snapshot and small file aggregation under a distributed file storage system, the method comprising:
S201: receiving, by a Metadata Server (MDS), an operation request sent by a client, when the operation request is an opening request, determining whether there is an O_TRUNC identifier in a file, and when there is the O_TRUNC identifier in the file, executing S202;
S202: determining, by the MDS, whether the file is an aggregated small file and has a snapshot, and when the file is the aggregated small file and has the snapshot, executing S203;
S203: returning, by the MDS, an error indicator to the client;
S204: converting, by the client, the aggregated small file into a normal small file after receiving the error indicator;
S205: after completing the conversion, sending, by the client, the opening request to the MDS again; and
S206: after receiving the opening request again, performing, by the MDS, a truncate operation, and triggering, by the MDS, a Copy-On-Write (COW) operation of an object of the small file, so as to ensure that snapshot data is correct.

2. The method according to claim 1, wherein determining whether the file is the aggregated small file in S202 comprises: determining whether a size of an original file is less than a first threshold.

3. The method according to claim 1, wherein converting, by the client, the aggregated small file into the normal small file in S204 comprises:
a) acquiring an aggregation attribute of the aggregated small file, finding and opening an aggregated large file according to the aggregation attribute, and reading data of the small file from the aggregated large file, wherein the aggregation attribute comprises an inode of the small file and an offset of the small file;
b) writing the data of the small file to a new object;
c) sending a setxattr request to update metadata of the small file in the MDS; and
d) emptying the inode of the small file in an object header in the aggregated large file.

4. The method according to claim 1, wherein in S201, when a file is opened in an O_TRUNC manner, after receiving a request, the MDS executes the truncate operation on the file to empty data of the file.

5. The method according to claim 1, wherein the operation request further comprises a deletion operation.

6. The method according to claim 5, wherein after receiving the deletion request sent by the client, the MDS determines whether there is an O_TRUNC identifier in the file, when there is the O_TRUNC identifier in the file, continues to determine whether the file is the aggregated small file and has the snapshot, and when the file is the aggregated small file and has the snapshot, returns the error indicator to the client; after receiving the error indicator, the client converts the aggregated small file into the normal small file, and sends the deletion operation to the MDS again; and after receiving the deletion request again, the MDS performs the truncate operation, and triggers the deletion operation of the object of the small file, so as to ensure that the snapshot data is correct.

7. The method according to claim 1, wherein the operation request further comprises a read operation:
a) when an object to be read is a snapshot, and the snapshot has an aggregation attribute;
b) acquiring metadata of a latest version of the snapshot, and acquiring an aggregation attribute of the metadata; and when an aggregation attribute of the latest version of the snapshot is not consistent with the aggregation attribute of the metadata, modifying the aggregation attribute of the metadata to the aggregation attribute of the latest version of the snapshot; and
c) continuing to perform the subsequent read operation.

8. The method according to claim 1, wherein when it is determined in S201 that there is no O_TRUNC identifier in the file, or it is determined in S202 that the file is not the aggregated small file or has no snapshot, the method ends.

9. The method according to claim 6, wherein when the MDS determines that there is no O_TRUNC identifier in the file, or determines that the file is not the aggregated small file and has the snapshot, the method ends.

10. (canceled)

11. A computer device, comprising a memory, one or more processors, and a computer-readable instruction that is stored in the memory and executable on the one or more processors, wherein the one or more processors, when executing the computer-readable instruction, implement following operations:
S201: receiving, by a Metadata Server (MDS), an operation request sent by a client, when the operation request is an opening request, determining whether there is an O_TRUNC identifier in a file, and when there is the O_TRUNC identifier in the file, executing S202;
S202: determining, by the MDS, whether the file is an aggregated small file and has a snapshot, and when the file is the aggregated small file and has the snapshot, executing S203;
S203: returning, by the MDS, an error indicator to the client;
S204: converting, by the client, the aggregated small file into a normal small file after receiving the error indicator;
S205: after completing the conversion, sending, by the client, the opening request to the MDS again; and
S206: after receiving the opening request again, performing, by the MDS, a truncate operation, and triggering, by the MDS, a Copy-On-Write (COW) operation of an object of the small file, so as to ensure that snapshot data is correct.

12. One or more non-volatile computer-readable storage media, storing a computer-readable instruction, wherein the computer-readable instruction, when being executed by one or more processors, enables the one or more processors to execute following operations:
S201: receiving, by a Metadata Server (MIDS), an operation request sent by a client, when the operation request is an opening request, determining whether there is an O_TRUNC identifier in a file, and when there is the O_TRUNC identifier in the file, executing S202;
S202: determining, by the MDS, whether the file is an aggregated small file and has a snapshot, and when the file is the aggregated small file and has the snapshot, executing S203;
S203: returning, by the MDS, an error indicator to the client;
S204: converting, by the client, the aggregated small file into a normal small file after receiving the error indicator;
S205: after completing the conversion, sending, by the client, the opening request to the MDS again; and
S206: after receiving the opening request again, performing, by the MDS, a truncate operation, and triggering, by the MDS, a Copy-On-Write (COW) operation of an object of the small file, so as to ensure that snapshot data is correct.

13. The method according to claim 7, wherein acquiring the metadata of the latest version of the snapshot, and acquiring the aggregation attribute of the metadata; and when the aggregation attribute of the latest version of the snapshot is not consistent with the aggregation attribute of the metadata, modifying the aggregation attribute of the metadata to the aggregation attribute of the latest version of the snapshot comprises:
acquiring metadata of a head version;
when an aggregation attribute of the head version is inconsistent with an aggregation attribute of the metadata, determining that defragmentation occurs, and modifying the aggregation attribute of the metadata to the aggregation attribute of the head version.

14. The method according to claim 13, further comprising:
when the head version has no aggregation attribute, determining that the data of the small file has changed.

15. The computer device according to claim 11, wherein determining whether the file is the aggregated small file in S202 comprises: determining whether a size of an original file is less than a first threshold.

16. The computer device according to claim 11, wherein converting, by the client, the aggregated small file into the normal small file in S204 comprises:
a) acquiring an aggregation attribute of the aggregated small file, finding and opening an aggregated large file according to the aggregation attribute, and reading data of the small file from the aggregated large file, wherein the aggregation attribute comprises an inode of the small file and an offset of the small file;
b) writing the data of the small file to a new object;
c) sending a setxattr request to update metadata of the small file in the MDS; and
d) emptying the inode of the small file in an object header in the aggregated large file.

17. The computer device according to claim 11, wherein in S201, when a file is opened in an O_TRUNC manner, after receiving a request, the MDS executes the truncate operation on the file to empty data of the file.

18. The computer device according to claim 11, wherein the operation request further comprises a deletion operation.

19. The computer device according to claim 18, wherein the one or more processors, when executing the computer-readable instruction, implement following operations:
after receiving the deletion request sent by the client, determining, by the MDS, whether there is an O_TRUNC identifier in the file, when there is the O_TRUNC identifier in the file, continuing to determine whether the file is the aggregated small file and has the snapshot, and when the file is the aggregated small file and has the snapshot, returning the error indicator to the client;
after receiving the error indicator, converting, by the client, the aggregated small file into the normal small file, and sending the deletion operation to the MDS again; and after receiving the deletion request again, performing, by the MDS, the truncate operation, and triggering the deletion operation of the object of the small file, so as to ensure that the snapshot data is correct.

20. The computer device according to claim 11, wherein the operation request further comprises a read operation, and the one or more processors, when executing the computer-readable instruction, implement following operations:
a) when an object to be read is a snapshot, and the snapshot has an aggregation attribute;
b) acquiring metadata of a latest version of the snapshot, and acquiring an aggregation attribute of the metadata; and when an aggregation attribute of the latest version of the snapshot is not consistent with the aggregation attribute of the metadata, modifying the aggregation attribute of the metadata to the aggregation attribute of the latest version of the snapshot; and
c) continuing to perform the subsequent read operation.

21. The computer device according to claim 11, wherein the one or more processors, when executing the computer-readable instruction, end the flow when it is determined in S201 that there is no O_TRUNC identifier in the file, or it is determined in S202 that the file is not the aggregated small file or has no snapshot.
